(19) United States
(12) Patent Application Publication
(10) Pub. No.: US 2011/0174585 A1
(43) Pub. Date: Jul. 21, 2011

(54) PROCEDURE FOR COUPLING AN AUTOMATIC TRANSMISSION

(75) Inventors: Hans KLEILA, Russelsheim (DE); Gernot BECKER, Mainz (DE)

(73) Assignee: GM GLOBAL TECHNOLOGY OPERATIONS LLC, Detroit, MI (US)

(21) Appl. No.: 13/009,410

(22) Filed: Jan. 19, 2011

(30) Foreign Application Priority Data
Jan. 19, 2010 (DE) 102010004912.3

(51) Int. Cl. F16H 45/02; F16D 48/00

(52) U.S. Cl. 192/3.28; 192/82 R

(57) ABSTRACT

A method is provided for coupling an automatic transmission of a motor vehicle, in which torque generated by an engine and applied to an input shaft is relayed by means of a torque converter and/or by means of a bridging coupling for bridging the torque converter to an output shaft. After the initiation of a bridging procedure, the torque is reduced, after which the bridging coupling is closed. This method enables an improved efficiency when coupling the automatic transmission.

### CROSS-REFERENCE TO RELATED APPLICATION

This application claims priority to German Patent Application No. 102010004912.3, filed Jan. 19, 2010, which is incorporated herein by reference in its entirety.

### TECHNICAL FIELD

The technical field relates to a method that is used to couple an automatic transmission of a motor vehicle. The technical field further relates to a drive train of a motor vehicle used to relay a torque generated by an engine from an input shaft to an output shaft.

### BACKGROUND

The torque of a motor vehicle with an automatic transmission is usually relayed from the crankshaft via a torque converter to the automatic transmission. To optimize the overall efficiency of the transmission, the torque converter can be provided with a bridge coupling, which is closed at higher gears as a function of engine speed and load. The disadvantage is that operation via the torque converter is always associated with comparatively large energy losses, so that coupling an automatic transmission entails high efficiency losses.

Therefore, at least one object is to provide a method for coupling an automatic transmission of a motor vehicle, as well as a drive train for a motor vehicle, which enables an improved efficiency when coupling an automatic transmission. In addition, other objects, desirable features and characteristics will become apparent from the subsequent summary and detailed description, and the appended claims, taken in conjunction with the accompanying drawings and this background.

### SUMMARY

The object is achieved according to the invention by means of a method, as well as by a drive train. In the method for coupling an automatic transmission of a motor vehicle, a torque generated by an engine and applied to an input shaft is relayed by means of a torque converter and/or a bridging coupling for bridging the torque converter to an output shaft. After the initiation of a bridging procedure, the torque is reduced, after which the bridging coupling is closed.

This method enables an improved efficiency when coupling an automatic transmission. The reduced engine torque when closing the bridging coupling of the torque converter makes it possible to close the bridging coupling after a startup procedure at a distinctly earlier time, thereby reducing the energy losses of the torque converter. The reduced torque causes the speed of the input shaft to rapidly drop either immediately or at the latest right after the bridging coupling has closed. In turn, this causes the slip speed of the bridging coupling to drop very rapidly as well. This shortens the time for which the closed bridging coupling runs with slip. Since most of the wear to the bridging coupling takes place in this period, this wear is hence greatly reduced. As a consequence, reducing the torque according to the invention allows the bridging coupling to close even in load cases that would lead to intensive wear without this torque reduction. For example, the bridging coupling can hence be closed at a distinctly earlier time after a startup procedure. As a result, the residual slip that always remains with each torque converter with the bridging coupling not closed can be quickly circumvented. In addition, reducing the torque reduces the shifting motion when closing the bridging coupling, improving the driving comfort of the vehicle. A bridging procedure can here be initiated using a signal from a control unit of the drive train in the vehicle as a function of the drive train configuration should it be necessary to close the bridging coupling. For example, such a necessity to close the bridging coupling might arise after completion of the startup procedure already with the automatic transmission shifted into first gear.

In particular, the torque can be reduced by decreasing the torque generated by the engine and applied to the input shaft. For example, this can be accomplished by limiting the engine output on the engine side. Closing the bridging coupling diverts the power flux of the torque generated by the engine from the torque converter to the bridging coupling. The bridging coupling is here completely closed as soon as no significant slip exists any more between the input and output shaft.

Before the bridging coupling is closed, a torque applied to the input shaft is preferably reduced to a maximum value of approximately 200 Nm, in particular of approximately 180 Nm, and especially preferred of approximately 160 Nm. Because an initially higher torque is reduced to such a maximum value before the torque converter is bridged by closing the bridging coupling, the wear of the bridging coupling can be diminished to a point that enables earlier bridging. The bridging coupling can be closed already with the automatic transmission shifted into first gear, for example, while the bridging coupling is normally closed only in second or third gear without a preceding torque reduction.

It is preferred that the bridging coupling be closed when the automatic transmission connected with the output shaft shifts into a first forward gear. The greatest forces are at work while the automatic transmission shifts into first gear, and hence when the transmission ratio of the gearing is lowest. Because the bridging coupling can already be closed when shifting into this gear, the working area of the bridging coupling is nearly maximized, thereby nearly minimizing the losses.

In particular, the bridging coupling can remain closed as the automatic transmission connected with the output shaft shifts into each ensuing forward gear. As a result, the function of the torque converter can be reduced to purely a startup coupling. After startup, the bridging coupling is closed one time, and not released again until the next startup procedure. As a result, the energy losses caused by the torque converter are also encountered only one time during startup.

Preferably used as the torque converter is a hydrodynamic torque converter, in particular a Trilok converter, where the bridging coupling is closed at speed differences between the input shaft and output shaft lying in the conversion area of the Trilok converter. Trilok converters utilize a sophisticated technology that combines the advantages of a torque converter and a flow coupling. The ability to bridge in the conversion area already helps to further expand the working area of the bridging coupling. The conversion area of a torque converter is the area where torque is excessive, so that the torque is intensified. Typically, a so-called coupling point separates the conversion area of a torque converter from the coupling area where torque is not intensified.

In particular a friction coupling is used as the bridge coupling. Friction couplings offer an easy way to non-positively couple elements rotating at different speeds. As soon as a speed adjustment has been achieved for the friction surfaces, there are no more significant friction losses. For example, a single lamella coupling is possible in the present case.

It is especially preferred that the torque be reduced before the bridge coupling is closed given a motor vehicle having a maximum torque ranging from approximately 250 Nm to approximately 700 Nm and/or a standstill speed ranging from approximately 2,000 RPM to approximately 3,000 RPM. Elevated loss reduction potentials arise in these vehicles with high engine outputs and loosely configured torque converters. For example, in a torque converter, an impeller connected with the input shaft in a torsion-resistant manner imparts motion to a fluid toward a turbine wheel, which is in turn made to rotate by the fluid. The turbine wheel is in turn connected with the output shaft in a torsion-resistant manner. The standstill speed is the speed established at equilibrium while the engine operates under a full load and the turbine wheel of the torque converter is secured in place. To determine this speed, the turbine wheel is blocked, and the engine drives the impeller. A strong engine makes it possible to close the bridging coupling early according to the invention, since the reduction in engine speed can be quickly compensated again by the high force reserves after the bridge coupling has been completely closed.

The torque is preferably reduced prior to closing the bridging coupling by decreasing the quantity of fuel-air mixture supplied to the combustion chamber of the engine and/or the quantity of fuel supplied to the combustion chamber of the engine. Therefore, torque reduction can take place on the engine side as a function of engine type.

A drive train for a motor vehicle comprises an input shaft and output shaft for transmitting a torque generated by an engine. The input shaft can be connected with the output shaft by means of a torque converter and bridging coupling, and he output shaft can be connected with an automatic transmission. A control unit is provided to control the torque, and designed in such a way that the torque applied to the input shaft can be reduced based on the method described above. This type of drive train can be used to achieve an improved efficiency when coupling an automatic transmission.

The torque converter is preferably designed as a hydrodynamic torque converter, in particular as a Trilok converter. A Trilok converter combines the positive attributes of a torque converter and a flow coupling. The bridging coupling is preferably configured like a friction coupling. Friction couplings offer an easy way to non-positively couple elements rotating at different speeds.

### BRIEF DESCRIPTION OF THE DRAWINGS

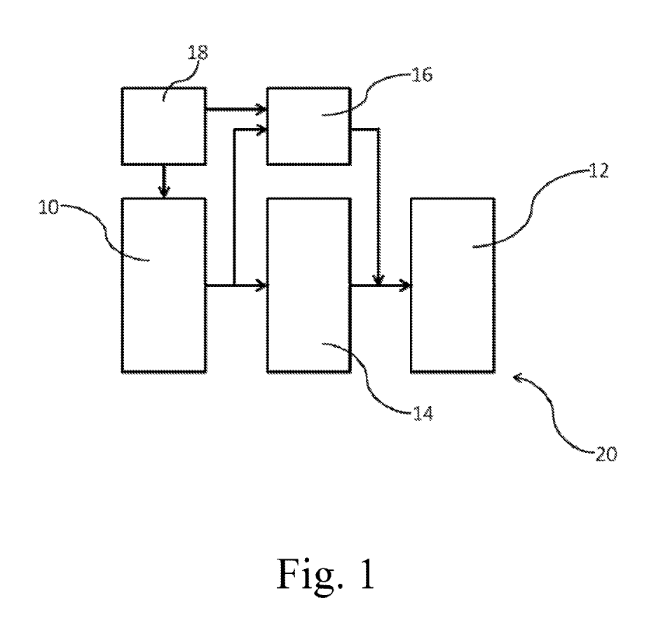

The present invention will hereinafter be described in conjunction with the following drawing FIG. 1 that shows a diagrammatic view of a drive train according to an embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

The drive train 20 of a motor vehicle shown on FIG. 1 has an engine 10, which generates a torque, a torque converter 14 and/or a bridging coupling 16 relays the power flux of this torque to an automatic transmission 12. The drive train 20 further exhibits a control unit 18, which controls the torque as well as the closure of the bridging coupling 16 when initiating the conversion of power flux from the torque converter 14 to the bridging coupling 16. For example, the power flux initially always takes place via the torque converter 14 after a startup procedure. Once the time at which the power flux is to be diverted to the bridging coupling 16 has been reached, the control unit 18 initiates the bridging procedure. The control unit 18 first sends a control signal to the engine 10, thereby reducing the torque currently being generated by the latter. After the torque has been reduced in response to the control signal, the control unit 18 sends a control signal to the bridging coupling 16, thereby closing the latter. As soon as the bridging coupling 16 has been completely closed, meaning that there is no more significant slip, the bridging procedure is concluded, and the power flux of the torque runs completely over the bridging coupling 16.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for coupling an automatic transmission of a motor vehicle, comprising:
generating a torque with an engine;
applying the torque to an input shaft;
bridging a torque converter to an output shaft;
reducing the torque after an initiation of the bridging; and
closing the bridging after reducing the torque.

2. The method according to claim 1, further comprising reducing the applying the torque to the input shaft to a maximum value of approximately 200 Nm before closing the bridging.

3. The method according to claim 1, further comprising reducing the applying the torque to the input shaft to a maximum value of approximately 180 Nm before closing the bridging.

4. The method according to claim 1, further comprising reducing the applying the torque to the input shaft to a maximum value of approximately 160 Nm before closing the bridging.

5. The method according to claim 1, wherein closing the bridging when the automatic transmission is connected with the output shaft and shifts into a first forward gear.

6. The method according to claim 5, wherein the closing the bridging remains closed as the automatic transmission is connected with the output shaft and shifts into an ensuing forward gear.

7. The method according to claim 1, wherein a hydrodynamic torque converter is used as the torque converter and the bridging coupling is closed at speed differences between the input shaft and the output shaft lying in a conversion area of the hydrodynamic torque converter.

8. The method according to claim 7, wherein the hydrodynamic torque converter is a Trilok converter.

9. The method according to claim 1, wherein a friction coupling is used as the bridging coupling.

10. The method according to claim 1, wherein reducing the torque before closing a bridge coupling given the motor vehicle having a maximum torque ranging from approximately 250 Nm to approximately 700 Nm.

11. The method according to claim 1, wherein reducing the torque before closing a bridge coupling given the motor vehicle having a standstill speed ranging from approximately 2,000 RPM to approximately 3,000 RPM.

12. The method according to claim 1, wherein reducing the torque is reduced prior to closing the bridging coupling by decreasing a quantity of fuel-air mixture supplied to a combustion chamber of the engine .

13. The method according to claim 1, wherein reducing the torque is reduced prior to closing the bridging coupling by decreasing a quantity of fuel supplied to a combustion chamber of the engine.

14. A drive train for a motor vehicle including an engine, comprising:
an input shaft and an output shaft for transmitting a torque generated by the engine;
a torque converter and a bridging coupling connecting the input shaft with the output shaft;
an automatic transmission connected to the output shaft; and
a control unit adapted to control:
generation of the torque with the engine;
application of the torque to the input shaft;
reduction of the torque after an initiation of a bridging; and
closing the bridging after reducing the torque.

15. The drive train according to claim 14, wherein the torque converter is as a hydrodynamic torque converter.

16. The drive train according to claim 15, wherein the hydrodynamic torque converter is a Trilok converter.

17. The drive train according to claim 14, wherein the control unit is further adapted to control the reduction by the applying the torque to the input shaft to a maximum value of approximately 200 Nm before closing the bridging.

18. The drive train according to claim 14, wherein the control unit is further adapted to control the reduction by the applying the torque to the input shaft to a maximum value of approximately 180 Nm before closing the bridging.

19. The drive train according to claim 14, wherein the control unit is further adapted to control the reduction by the applying the torque to the input shaft to a maximum value of approximately 160 Nm before closing the bridging.

20. The drive train according to claim 14, wherein closing the bridging when the automatic transmission is connected with the output shaft and shifts into a first forward gear.
